(19) United States
(12) Patent Application Publication
(10) Pub. No.: US 2009/0006152 A1
(43) Pub. Date: Jan. 1, 2009

(54) System and method for estimating a new content level in service agreements

(75) Inventors: Chad Michael Timmerman, Chillicothe, IL (US); Robert Edward Bacon, Peoria, IL (US); Stewart Eugene Rives, Morton, IL (US); Joshua Scott Duncan, Pekin, IL (US); John Robert Milner, Peoria, IL (US); Mahesh Srinivasan, Dunlap, IL (US); Ruben Perez, JR., Peoria, IL (US); Kelly Norbert Thelen, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/819,781

(22) Filed: Jun. 29, 2007

(51) Int. Cl. G06F 17/00

(52) U.S. Cl. 705/7

(57) ABSTRACT

A method for estimating a new content level in service agreements comprises defining a plurality of service requirement options associated with supply chain management processes and establishing a weight factor for each service requirement option. The service requirement options are provided to an interactive interface that allows a user to select one or more service requirement options to include in a desired supply chain management process. A plurality of user-selected service requirement options associated with the desired supply chain management process is received from the interactive interface. A new content level associated with the desired supply chain management process is determined and provided to one or more service requirement subscribers.

### TECHNICAL FIELD

The present disclosure relates generally to analyzing service agreements between a service provider and a customer and, more particularly, to systems and methods for estimating a new content level in service agreements.

### BACKGROUND

Supply chain management is an integral part of any organization whose business relies on storage, maintenance, tracking, distribution, and/or management of raw materials and saleable goods. In fact, supply chain management has become so critical to the successful performance of certain business operations that some organizations subcontract portions of their supply chain processes to third party logistics providers that specialize in evaluating a company's supply chain management needs and providing supply chain management solutions based on the specific needs of the company.

Like many other services, the scope and cost of supply chain or logistics management services are largely based on the specific requirements of the environment in which they are deployed. For example, supply chain operations associated with a small company that operates retail stores in a relatively concentrated geographic region may require far less supply chain oversight and management than supply chain operations associated with large, multinational corporations with manufacturing, distribution, and storage facilities located around the world. Moreover, some companies manufacture, store, and/or distribute specialized goods that may require customized supply chain management solutions to accommodate the specialized goods. Because customer supply chain requirements can vary dramatically depending upon the size of the inventory and type of goods that are stocked, it may be difficult for the customer to select a supply chain service provider with capabilities that conform to the needs of the customer. Thus, in order to determine if existing supply chain management processes associated with a service provider align well with the supply chain management requirements of a potential customer, a process for objectively evaluating customer requirements with the proven supply chain capabilities of a service provider may be required.

Some processes have been developed that are directed toward enabling service providers to evaluate a proposed service project, estimate feasibility and risk associated with the proposed service project, and take certain measures to mitigate the service provider's risk. One such process is described in U.S. Patent Publication No. 2004/0098300 (“the '300 patent”) to Karwatowski et al. The '300 publication describes a method for optimizing project management and quality assurance processes for a project by estimating a general risk factor associated with the project. The risk factor may be determined based on the cost of the project, the scope and complexity of the project, and skills and experience of members of the project implementation team. As the risk associated with the project increases, the amount of project oversight that is required by a manager or technology expert may be increased in an effort to minimize potential failures in performance.

Although the process of the '300 publication may determine risks associated with a project in certain situations, it may be insufficient. For example, the system of the '300 publication generally characterizes risk into one of three broad categories (low risk, medium risk, and high risk) based on subjectively identified “areas of concern.” The system of the '300 publication may not, however, estimate the amount of new content that must be added to existing project management capabilities in order to meet the customer requirements. Because the system of the '300 publication may not quantify the impact that the design and implementation of new content may have on an existing project management processes, it may be difficult for organizations to accurately estimate costs and risks associated with creating, testing, and implementing the new content within the existing project management processes.

The presently disclosed system and method for quantifying compatibility between existing service capabilities and customer service requirements are directed toward overcoming one or more of the problems set forth above.

### SUMMARY OF THE INVENTION

In accordance with one aspect, the present disclosure is directed toward a method for estimating an amount new content in service agreements. The method may include defining a plurality of service requirement options associated with supply chain management processes and establishing a weight factor for each service requirement option. The service requirement options may be provided to an interactive interface that allows a user to select one or more of the service requirement options for inclusion in a desired supply chain management process. A plurality of user-selected service requirement options associated with the desired supply chain management process may be received from the interactive interface. A new content level associated with the desired supply chain management process may be determined and provided to one or more service requirement subscribers.

According to another aspect, the present disclosure is directed toward a method for determining a new content level associated with a desired service process. The method may include receiving one or more service requirement options associated with a desired supply chain management process. The method may also include determining whether a received service requirement option corresponds to an existing supply chain management process, a modification of an existing supply chain management process, or a new supply chain management process based on the desired service requirement specification. An adjustment factor associated with the desired service requirement option may be selected based on the determination. A new content level associated with the desired supply chain management process may be estimated based on a weight factor associated with the one or more service requirement options and the assigned adjustment factor. The new content level may be provided to one or more subscribers associated with the desired supply chain management process.

In accordance with yet another aspect, the present disclosure is directed toward a system for estimating a new content level in service agreements. The system may include a service requirement definition module having an interactive interface that allows a user to assign a weight factor to one or more service requirement options. The system may also include a service requirement selection module communicatively coupled to the project definition module. The service requirement selection module may provide an interactive interface for selecting one or more service requirement options associated with a desired service agreement. The system may further include a processor operatively coupled to one or more of the service requirement definition module and service requirement selection module. The processor may be configured to receive selected service requirement options from the service requirement selection module, determine a new content level associated with the service agreement based on the weight factors associated with the selected service requirements, and provide the new content level to one or more service requirement subscribers.

### BRIEF DESCRIPTION OF THE DRAWINGS

FIG. 1 illustrates a service agreement analysis environment in which processes and methods consistent with the disclosed embodiments may be implemented;

FIG. 2 provides a flowchart illustrating a method for identifying and quantifying new content in service agreements in accordance with certain disclosed embodiments; and

FIG. 3 provides a flowchart depicting a method for determining a new content level associated with a desired service process consistent with the disclosed embodiments.

### DETAILED DESCRIPTION

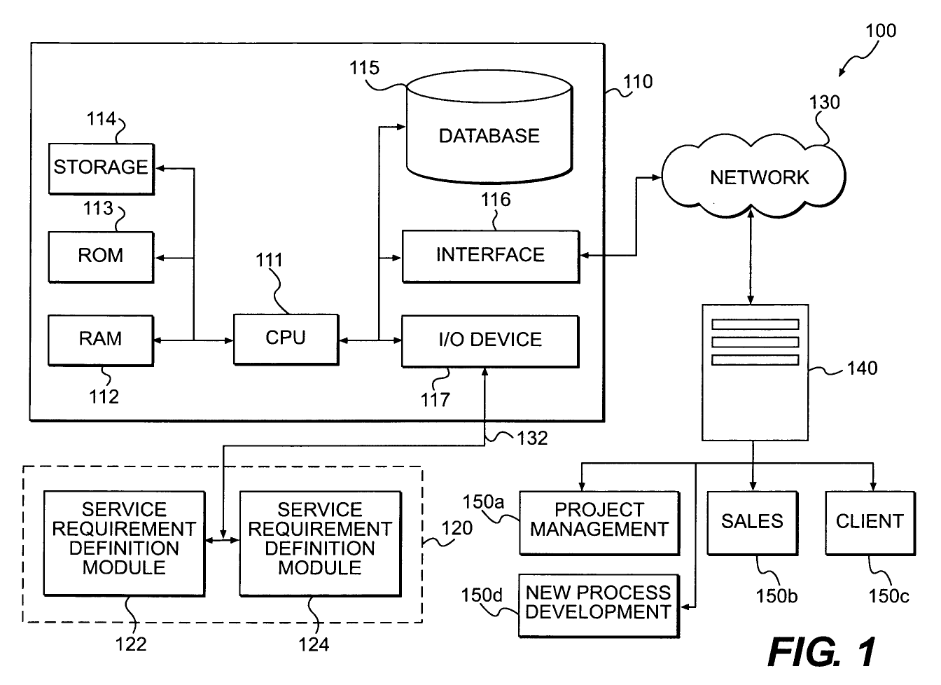

FIG. 1 illustrates a service agreement analysis environment 100 in which processes and features associated with the disclosed embodiments may be implemented. Service agreement analysis environment 100 may include one or more components, each of which may be adapted to perform one or more tasks consistent with the disclosed service agreement analysis process. Service agreement analysis environment 100 may include, for example, a system 110 for analyzing service requirements. System 110 may be communicatively coupled to an interactive interface 120 for receiving service requirement options associated with a desired service agreement. Service agreement analysis environment 100 may also include a network 130 for facilitating data communications between service requirement analysis system 110 and one or more back-end systems, such as a service agreement server 140 or one or more service agreement subscribers 150a-d. Service agreement analysis environment 100 may include additional, fewer, and/or different components or systems than those listed above. Furthermore, processes and features associated with the disclosed embodiments support additional configurations of service agreement analysis environment 100 than those illustrated in FIG. 1. For example, although interactive interface 120 is illustrated as being a standalone system, it is contemplated that interactive interface may embody a hardware or software subsystem of service requirement analysis system 110.

Service agreement analysis environment 100 may be configured to provide a medium that enables potential customers to identify and select particular service requirement options associated with services offered for sale by a service provider. According to one embodiment, service agreement analysis environment 100 may be associated with supply chain management services offered by a logistics service provider. As such, service agreement analysis environment 100 provides a medium that allows a customer to customize a supply chain management solution by selecting service requirement options offered by a third party logistics provider. Service requirement option, as the term is used herein, refers to one or more user-selectable options, specifications, or requirements of a task or subtask, service, process, or equipment that may be associated with a particular service offering. For example, service requirement options for supply chain management solutions may include processes that support customer order management (e.g., order entry, order maintenance, order processing, order allocation, etc.); customer service solutions (e.g., call center support and management, customer billing, etc.); pricing and billing solutions; manufacturing solutions (raw material acquisition; demand forecasting, etc.); inventory and material management (e.g., demand forecasting, requirements planning, vendor and supplier management, etc.); distribution and warehouse management solutions (e.g., shipping and receiving, inventory validation; quality assurance, etc.); transportation management (e.g., scheduling, carrier selection, tracking, etc.); compliance (e.g., import/export control, customs, tax and tariff, disposal management; and technology management and support (e.g., call center support, network infrastructure to support logistics operations, systems integration between third party systems and in-house systems, etc.). Service requirement options may include additional, fewer, and/or different options than those listed above. As indicated above, service requirement options may be divided or grouped into a plurality of subcategories.

Those skilled in the art will recognize that service agreement analysis environment 100 is not limited to supply chain management solutions associated with logistics service providers, and may be implemented in any suitable service-oriented industry. According to an alternate embodiment, service agreement analysis environment 100 may be associated with repair services offered by an automotive service provider. As such, service requirement options may include one or more service options that are offered to customers at an automotive service shop. Each option may define a particular activity that may be performed as part of an automotive service agreement. Each service option may be subdivided into a plurality of subtasks, providing the customer with more flexibility in defining the scope and price of the service agreement.

System 110 may include any type of processor-based system on which processes and methods consistent with the disclosed embodiments may be implemented. As illustrated in FIG. 1, system 110 may include one or more hardware and/or software components configured to execute software programs, such as software for managing service agreement analysis environment 100. For example, system 110 may include one or more hardware components such as, for example, a central processing unit (CPU) 111, a random access memory (RAM) module 112, a read-only memory (ROM) module 113, a storage 114, a database 115, an interface 116, and one or more input/output (I/O) devices 117. Alternatively and/or additionally, system 110 may include one or more software components such as, for example, a computer-readable medium including computer-executable instructions for performing methods consistent with certain disclosed embodiments. It is contemplated that one or more of the hardware components listed above may be implemented using software. For example, storage 114 may include a software partition associated with one or more other hardware components of system 110. System 110 may include additional, fewer, and/or different components than those listed above. It is understood that the components listed above are exemplary only and not intended to be limiting.

CPU 111 may include one or more processors, each configured to execute instructions and process data to perform one or more functions associated with system 110. As illustrated in FIG. 1, CPU 111 may be communicatively coupled to RAM 112, ROM 113, storage 114, database 115, interface 116, and I/O devices 117. CPU 111 may be configured to execute sequences of computer program instructions to perform various processes, which will be described in detail below. The computer program instructions may be loaded into RAM for execution by CPU 111.

RAM 112 and ROM 113 may each include one or more devices for storing information associated with an operation of system 110 and/or CPU 111. For example, ROM 113 may include a memory device configured to access and store information associated with system 110, including information for identifying, initializing, and monitoring the operation of one or more components and subsystems of system 110. RAM 112 may include a memory device for storing data associated with one or more operations of CPU 111. For example, ROM 113 may load instructions into RAM 112 for execution by CPU 111.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by system 110 and/or CPU 111. For example, database 115 may include specifications for service requirements associated with one or more previously implemented service processes related to a previously executed service agreement. CPU 111 may access the information stored in database 115 for comparing proposed service requirements with existing or previously implemented service requirements to determine a level of new content that may be required to implement and execute a proposed service agreement. It is contemplated that database 115 may store additional and/or different information than that listed above.

Interface 116 may include one or more components configured to transmit and receive data via a communication network, such as the Internet, a local area network, a workstation peer-to-peer network, a direct link network, a wireless network, or any other suitable communication platform. For example, interface 116 may include one or more modulators, demodulators, multiplexers, demultiplexers, network communication devices, wireless devices, antennas, modems, and any other type of device configured to enable data communication via a communication network.

I/O devices 117 may include one or more components configured to communicate information with users associated with system 110. For example, I/O devices may include a console with an integrated keyboard and mouse to allow users to input parameters associated with system 110. I/O devices 117 may also include a display including a graphical user interface (GUI) for outputting information on a monitor. I/O devices 117 may also include peripheral devices such as, for example, a printer for printing information associated with system 110, a user-accessible disk drive (e.g., a USB port, a floppy, CD-ROM, or DVD-ROM drive, etc.) that allows users to input data stored on a portable media device, a microphone, a speaker system, or any other suitable type of interface device.

Interactive interface 120 may embody a software or hardware tool that provides an medium for conducting business between a service provider and one or more potential customers. Interactive interface 120 may include, for example, a software program that allows potential customers to select from a list of available services offered by a service provider. As such, interactive interface 120 may be loaded onto one or more existing computer systems and/or electronically distributed, via email or other suitable medium, to system 110 or one or more other computer systems. Interactive interface 120 may include a stand-alone, computer-executable application or, alternatively, may embody a document or file associated with an existing application.

According to one embodiment, interactive interface 120 may embody one or more electronic checklists associated with system 110 that provide a plurality of service requirement options to a user. The electronic checklists may be configured to detect selections made by a user of the checklist and record the selections in a selection database. System 110 may create a proposed service agreement corresponding to the service requirement selections. System 110 may also calculate a new content level associated with proposed service agreement based on the capabilities of existing services and processes offered by the service provider.

Interactive interface 120 may be communicatively coupled to system 110. As noted above, interactive interface 120 may be a software-executable file for use on or with system 110 or any other computer system. As such, computer systems implementing interactive interface 120 may be communicatively coupled to system 110 via communication network 130 or one or more direct data links 132. These systems may be configured to transmit selected service requirement options associated with interactive interface 120 to system 110 for analysis. Alternatively and/or additionally, computer systems that execute interactive interface 120 may be configured to receive information, such as software updates, interface enhancements, or any other information from system 110.

Interactive interface 120 may include one or more service requirement modules that allow service providers, potential customers, and other users of interactive interface 120 to access or update one or more features of the interface. Interactive interface 120 may include, for example, a service requirement definition module 122 and a service requirement selection module 124.

Service requirement definition module 122 may provide an interface for defining, adding, amending, or removing one or more service requirement options provided to the customer. Additionally, service requirement definition module 122 may provide an interface that allows service provider personnel to define weight factors associated with the service requirement options that are used by system 110 in analyzing the service agreement. Weight factors, as the term is used herein, refer to a value indicative of the impact that a particular service requirement option has on the overall performance of a service agreement or a process associated with the service agreement. According to one embodiment, weight factors may embody numerical values between 1 and 9. Service requirement options having the least impact on a service agreement process may be assigned a value of 1 and options having the most impact on the process may be assigned a value of 9. The assignment of weight factors may be based on the analysis of historical data associated with previously executed processes and may be proportional to how modifications of a particular service requirement may have affected the previously executed process. For example in a supply chain management environment, historical data may indicate that material forecast optimization process executed in a previous inventory management process resulted in a 5% decrease in backordered or delayed items. Accordingly, a service requirement option associated with a material forecast optimization process may be assigned a weight of “9”, indicating that this option has a high impact on the success of the inventory management process. Similarly, historical data may indicate that the type of invoice or billing process used in previous supply chain management processes had little or no impact on the success of an inventory management process. Accordingly, service requirement options associated with invoice and billing processes may be assigned a value of “1”, indicating that these processes have a very low impact on the inventory management process. It is contemplated that additional weight factor determination systems and values may be used and that the weight factor assignment processes discussed above are exemplary only and not intended to be limiting.

Service requirement definition module 122 may also be configured to calculate adjustment factors associated with service requirement options selected by a customer. Adjustment factor, as the term is used herein, refers to the amount of change associated with an existing service provider process that may be required to implement the service requirement options selected by the customer. Adjustment factors may be predetermined by a service provider and may based on one or more of the level of uncertainty of success associated with the change, a cost (e.g., time, money, resources) associated with making the appropriate change(s), an amount of infrastructure change required to make the requested change, an amount of impact that the proposed change may have on other processes or services, or any other potential impact that the change may have on an existing process. As with weight factors, adjustment factors may include a range of values that may be assigned as proportional to the amount of change required by the process.

Service requirement selection module 124 may embody the primary customer-interactive interface associated with service agreement analysis environment 100. For example, service requirement selection module 124 may include a graphical user interface (GUI) that may be configured to display one or more interactive checklists to a customer. As explained, these interactive checklists may provide the customer with a plurality of service requirement options to choose from. Once checklists are completed by the customer, service requirement selection module 124 may collect the service requirement options selected by the customer and store the selected options for analysis by system 110. It is contemplated that service requirement selection module 124 and service requirement definition module 122 are communicatively coupled such that certain changes made in service requirement definition module 122 may also affect a corresponding change in service requirement selection module 124.

Communication network 130 may be any network that facilitates communication between system 110 and a back-end system, such as service agreement server 140 and/or service requirement subscribers 150a-d. For example, communication network 130 may communicatively couple system 110 to one or more back-end systems across a wired or wireless networking platform such as, for example, the Internet, cellular, Bluetooth, satellite, microwave, point-to-point wireless, point-to-multipoint wireless, multipoint-to-multipoint wireless, or any other appropriate communication platform for networking one or more remote systems. According to one embodiment, communication network 130 may include a proprietary, secure telecommunications network that supports voice, video, and data communications via the Internet, e-mail, or any other communication medium.

Service agreement server 140 may include any computer system suitable for configuration as a centralized information gateway between system 110 and one or more service requirement subscribers 150a-d. Service agreement server 140 may include a database that collects service requirement information associated with a potential customer and distributes the information to the customer and/or one or more business entities associated with the service provider. Alternatively, service agreement server 140 may be configured to receive the service requirement information from system 110, store the information in a service requirement database, and provide service requirement analysis data for download by the customer and/or one or more business entities via a secure website.

Service requirement subscribers 150a-d may each include a computer system that is configured to receive data from service agreement server 140 or system 110 in a manner consistent with the disclosed embodiments. For example, service requirement subscribers 150a-d may include one or more computer terminals operated by respective users. Alternatively and/or additionally, service requirement subscribers 150a-d may include personal data assistant systems (PDA), wireless communication devices (e.g., pagers, phones, etc.), notebook computers, diagnostic computer systems, data analyzers, or any other such computing devices configured to receive and process information. Service requirement subscribers 150a-d may be associated with a particular division of a business entity associated with project environment 100, such as a project management division, a project implementation division, a customer or client, a new process development division, a service sales division, and/or any other business entity that may be associated with project environment 100.

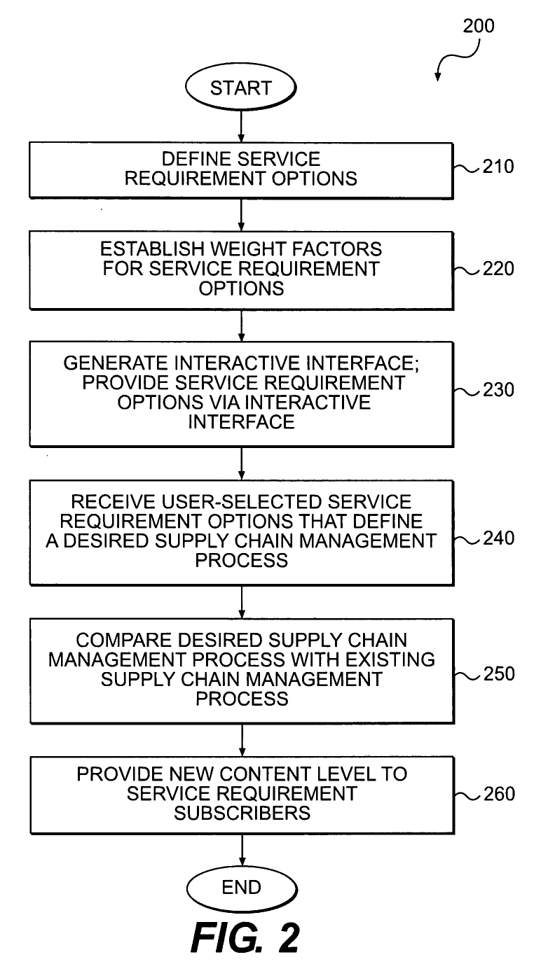

Processes and methods consistent with the disclosed embodiments provide a system for determining compatibility between existing capabilities of a service provider and particular service requirements specified by a customer. For example, the methods described herein enable service providers to calculate a new content level associated with a desired service agreement proposed by a customer. The new content level may be indicative of the amount of new material that may be required to be included in one or more existing processes to implement the desired customer process. Thus, proposed service agreements with high new content levels may require more changes to existing services than proposed agreements with low new content levels. FIG. 2 provides a flowchart 200 depicting an exemplary method for identifying and quantifying new content in service agreements, which may be used to measure compatibility between existing capabilities of a service provider and particular service requirements specified by a customer.

As illustrated in FIG. 2, a service provider may define one or more service requirement options associated with interactive interface 120 (Step 210). For example, service provider personnel may identify a plurality of service requirement options based on existing supply chain management process capabilities of the service provider. Each service requirement option may correspond to a particular supply chain management process that may be selected by a user as part of a desired service agreement. The defined service requirement options may be added to interactive interface 120 via service requirement definition module 122.

Once service requirement options have been identified and defined, weight factors associated with each service requirement option may be established (Step 220). As explained, weight factors may be indicative of the relative impact or criticality of a service requirement option on one or more processes associated with a service agreement. Further, weight factors may be based on historical data gathered from previous performance of supply chain management processes. Alternatively, weight factors may be established by technical experts associated with supply chain management processes based on empirical data gathered from observations of supply chain management processes. According to one embodiment, service requirement personnel may access service requirement definition module 122 of interactive interface 120 to define weight factors associated with each service requirement option.

Based on the service requirement and weight factor definitions, system 110 may provide service requirement options to service requirement selection module 124 of interactive interface 120 (Step 230). According to an exemplary embodiment, service requirement selection module 124 may comprise a graphical user interface configured to present one or more service requirement options defined by service requirement definition module 122. As explained, service requirement selection module 124 may present service requirement options in a checklist or spreadsheet format, providing customers with a list of options that may be electronically selected (using a mouse or other input device) for inclusion in a proposed supply chain management process.

System 110 may receive one or more service requirement options selected by a potential customer and compile the selected options to create a proposed service agreement (Step 240). According to one embodiment, after completing an electronic checklist provided by service requirement selection module 124 of interactive interface 120, a customer may save and/or upload the selections to storage 114 or database 115 of system 110. According to another embodiment, system 110 may receive the completed electronic checklist from a customer via email, instant message, or other suitable data transmission medium. Once received, system 110 may identify the selected options from among the available options and generate a proposed service agreement that includes the selected options. In addition system 110 may store the proposed service agreement in memory for further analysis by one or more business entities associated with the service provider.

System 110 may compare the desired supply chain management process defined by the customer with existing supply chain management processes (Step 250) to identify differences between the proposed process and an existing process. Any differences may be analyzed by system 110 and/or service requirement personnel to determine the degree to which the proposed process differs from an existing process. Based on the differences, system 110 may estimate a new content level associated with the proposed service agreement. This new content level may be expressed as a percentage and may be indicative of an estimated amount of new content that must be designed, tested, and implemented within an existing process in order to meet the service requirements contained in the proposed service agreement. The new content level may be based on the degree with which the proposed process differs from an existing process, and may also take into account the weight factor for one or more service requirement options in order to temper the impact of certain service requirement options that have little effect on the outcome of the process.

According to one embodiment, system 110 may analyze each service requirement option provided by the user with respect to a corresponding service requirement associated with an existing process that has been previously implemented by a service provider. This analysis may include determining a specific quantitative amount associated with any differences between the proposed and existing processes. For example, a customer may require an inventory management process that is capable of filling and shipping 99% of new part orders on time. System 110 may analyze previously implemented processes and determine that the highest order fill percentage that was previously implemented was 97.5%. System 110 or service provider personnel may estimate the amount of “new” process content that must be included into an existing process to reach the target customer fill percentage associated with this service requirement option.

System 110 may be configured to provide new content analysis information to one or more service requirement subscribers 150a-d (Step 260). For example, upon analyzing one or more service requirement options, system 110 may compile a report that summarizes the analysis associated with each service requirement option. The report may also provide new content information associated with the proposed service agreement and/or one or more service requirement options. System 110 may provide this report to one or more business divisions associated with the service provider such as, for example, a project management division, a new process development division, a sales division, etc. Each division may use the results to determine the compatibility between the proposed service agreement and the capabilities of the respective division. Moreover, each division may independently analyze the feasibility of implementation of the project and identify any risks associated with the implementation of the process. According to one embodiment, once a proposed service agreement has been analyzed by the service provider, system 110 may provide a report to client 150c summarizing analysis results and new content levels. This report may aid both the service provider and customer in determining whether to move forward with a proposed service agreement by identifying particular areas of incompatibility between the desired customer requirements and existing process specifications.

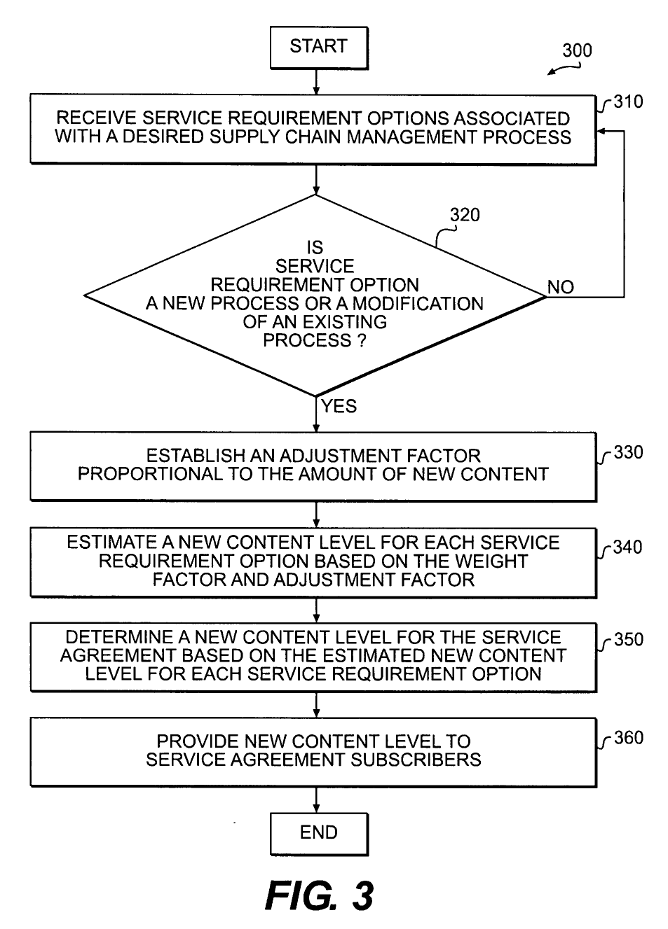

According to one embodiment, service requirement definition module 122 associated with interactive interface 120 may allow service provider personnel to establish specific new content adjustment factors that may be assigned to service requirement options selected by the user. These adjustment factors may be based on whether the service requirement option selected by the user requires development of a new process or modification of an existing process. By establishing uniform quantitative values associated with the amount of new process development required to implement proposed supply chain management processes, system 110 may provide a new content analysis tool that objectively analyzes proposed service agreements, thereby limiting uncertainty and inconsistency associated with subjective analysis methods. FIG. 3 provides a flowchart 300 depicting a method for determining new content in service agreements by establishing an adjustment factor for each service requirement option selected by a customer.

As illustrated in FIG. 3, system 110 may receive one or more customer-selected service requirement options associated with a desired supply chain management process (Step 310). Service requirement personnel (e.g., project manager, etc.) may analyze the proposed supply chain process associated with the selected service requirement options and determine whether the process constitutes a new process or is a modification of an existing process (Step 320). According to one embodiment, a service provider representative may analyze the selected service requirement options and determine whether the service requirement option is a new process (i.e., a process that has not been previously implemented, designed, and tested by the service provider), a modification to an existing process (i.e., a process that may be derived from an existing process, but which may require modifications or further testing to reliably implement the process), or an existing process (i.e., a process that has been implemented, designed, and tested). In some cases, to qualify as existing, the process may also require some degree of past success. Based on the determination, the service provider representative may classify each selected service requirement option one of “New” (corresponding to a new process), “Enhanced/Modified” (corresponding to an existing process with modifications, or “Existing” (corresponding to an existing process and requiring no modifications). To facilitate this classification, service requirement definition module 122 associated with interactive interface may provide a drop-down menu whereby service requirement personnel may designate a service requirement option as one of “New”, “Enhanced/Modified”, or “Existing” based on the amount of new content associated with the service requirement.

System 110 may assign an adjustment factor based on the designation of the service requirement option. For example, first and second adjustment factors may be assigned to options that been designated as “New” and “Enhanced/Modified”, respectively. Because designing and implementing completely new service requirement options are generally more difficult that making modifications to existing service requirement processes, the first adjustment factor is greater than the second adjustment factor. Moreover, because service requirement options designated as “Existing” may not require any adjustment or modification, the adjustment factor associated with “Existing” may be null.

If the service requirement option is not either a new process or a modification of an existing process (Step 320: No), indicating that the service requirement option constitutes an existing service provider process and, therefore, does not require implementation of new content to implement the service requirement option, system 110 continues analyzing subsequent service requirement option selections. If, on the other hand, the service require option requires design of a new process or a modification of an existing process (Step 320: Yes), service provider personnel may select/establish an appropriate adjustment factor based on the amount of new content required to implement the service requirement option in accordance with customer specifications (Step 330).

System 110 may estimate a new content level associated with each service requirement option based on the weight factor and any adjustment factors associated with a respective service requirement option (Step 340). For example, for each service requirement option selected, system 110 may determine/calculate the new content level as the weight factor multiplied by the adjustment factor. In certain situations where service requirements have been grouped into categories, it may be advantageous to normalize each weight factor with respect to the sum of the weight factors within the corresponding category. This may ensure that weight factors for categories containing large numbers of items do not outweigh categories with fewer items but which may have as significant an impact on the overall success of the process.

Once new content levels have been estimated for each service requirement option, a new content level for the service agreement or one or more service agreement categories may be determined (Step 350). The new content level for the service agreement may be determined as the sum of the new content levels for each of the service requirement options. Similarly, new content levels for one or more subcategories of a particular service agreement may be independently calculated as the sum of the service requirement options associated with the subcategory. By separately determining new content levels for service requirement options, subcategories of service requirement options, and service agreements, service providers and/or customers may be able to select which service requirement options to implement in a service agreement. As a result, should new content levels for a particular service requirement option be unacceptable to a service provider and/or a customer, those options may be removed from the agreement, without jeopardizing an entire service agreement.

Once new content analysis has been performed for a particular service agreement system 110 may provide data indicative of the new content analysis to one or more service requirement subscribers 150a-d (Step 360). As explained, system 110 may transmit the new content information to one or more service requirement subscribers 150a-d via network 130. Alternatively and/or additionally, new content information may be provided to a service requirement server 140 that may provide a secure system that allows one or more subscribers 150a-d to login and retrieve new content analysis reports and analysis information.

Certain embodiments described above provide automated processes for determining new content levels to determine the compatibility between proposed service requirements and existing capabilities of a service provider. Although these processes are described as being performed on or by one or more hardware or software systems, such as system 110, or interactive interface 120, it is contemplated that the methods and processes described above may be performed manually without the use of system 110 or interactive interface 120 or, alternatively, using a combination of manual and automated methods.

### INDUSTRIAL APPLICABILITY

Although the disclosed embodiments are described in connection with analyzing service agreements for logistics services in supply chain management environments, the methods and systems described above may be employed in any environment where it may be advantageous to analyze customized service requirements with respect to one or more existing services provided by a customer. Specifically, the presently disclosed systems and methods enable service providers to accurately and objectively analyze potential service agreements and bids based on requested service requirements from a customer, determine a new content level associated with the service agreement, and decide whether to proceed with the service agreement based on the new content level.

The presently disclosed systems and methods for determining compatibility between existing service capabilities and customer service requirements may have several advantages. For example, the presently disclosed system provides a quantitative new content percentage that allows potential customers to easily identify a service provider's strengths and weaknesses when compared to the customer's requirements. This quantitative approach provides customers with a more objective and accurate indication of the compatibility between existing capabilities of a service provider and customer requirements, particularly when compared with conventional risk assessment systems which subjectively identify potential “areas of risk” without analyzing specific existing service provider processes. As a result, the presently disclosed system and associated methods provides customers and service providers with a mechanism for comparing existing supply chain management services with service requirements specified in a proposed service agreement and quantifying the degree by which existing services must change in order to meet the terms specified in the service agreement.

According to one embodiment, the new content percentage may be used by an organization to control and/or mitigate certain risks associated with prospective projects. For example, an organization may establish new content ranges that prescribe predetermined actions to be taken if the new content percentage falls within a particular risk range. Those skilled in the art will recognize that relatively low new content percentages correlate with low risk percentages, while higher new content percentages correspond to higher risk percentages. The presently disclosed systems and methods allow project managers to objectively determine the new content level and perform one or more of the prescribed actions to mitigate the risks associated with implementing the project.

By way of example, a customer may submit a list of proposed requirements for a new contract to a service provider. A project manager may input the customer requirements into the new content identification tool, which processes the customer requirements in accordance with the current capabilities of the service provider. The new content identification tool may output a new content level, which is indicative of the amount of new content required to implement the proposed customer requirements. If this content level is less than a first predetermined percentage (e.g., 10%), the project manager may prescribe minimal modifications to existing oversight processes. For example, a project manager may prescribe slightly more senior management oversight (e.g., only at critical project milestones) than would be required for an existing project with no new content level. If the new content level is greater than a first predetermined percentage, but less than a second predetermined percentage (e.g., 25%), the project manager may prescribe more frequent senior management oversight to ensure that the project is meeting target completion levels. Furthermore, the project manager may also embed a particular scope management process to ensure that the implementation of new content meets the proposed customer requirements.

If the new content level exceeds the second predetermined percentage, but is less than a third predetermined percentage (e.g., 40%), the project manager may designate a specialized project implementation team. This team may comprise highly experienced project managers and/or subject matter experts. Furthermore, the project manager may also schedule more frequent senior management reviews to ensure that the implementation of the project is consistent with the proposed customer requirements. The project manager may also establish a high risk identifier in a risk management tool. The risk management tool may monitor risk levels associated with a plurality of service provider contracts to ensure that the service provider does not take on too many high-risk contracts that could impose potentially excessive financial liability on the service provider.

Finally, if the new content level exceeds the third predetermined percentage, the risk assessment for the project may be substantial. Accordingly, should the customer still desire a contract for the performance of the proposed project, the contract may be modified to mitigate the risk to the service provider. For example, the contract may include cost and schedule overrun provisions, whereby certain cost and schedule overrun risks are borne by the customer. Furthermore, the project manager may schedule frequent account management interaction with the customer to keep the customer informed of such cost and schedule overruns, as they become necessary. Additionally, the project manager may staff the project implementation team with highly experienced project manager and/or subject matter experts, which may report very frequently (e.g., daily, hourly, etc.) to a senior manager, who may, in turn, keep the customer informed as to the status of the project.

The systems and methods described herein provide a tool that allows customer and service providers to determine a new content level associated with a proposed service agreement. The new content level may be compared with predetermined new content ranges, which prescribe particular actions to be taken to mitigate risks associated with the particular new content level. These actions may include providing additional/more experienced oversight of particular high-risk project areas, requiring additional senior management oversight, modifying a service agreement to balance or shift cost and schedule overruns, and/or adjusting a cost associated with implementing the proposed service agreement.

It will be apparent to those skilled in the art that various modifications and variations can be made to the presently disclosed system for quantifying compatibility between existing service capabilities and proposed service requirements. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for estimating new content in service agreements comprising:
defining a plurality of service requirement options associated with supply chain management processes;
establishing a weight factor for each service requirement option;
providing the service requirement options via an interactive interface that allows a user to select one or more of the service requirement options for inclusion in a desired supply chain management process;
receiving a plurality of user-selected service requirement options associated with the desired supply chain management process from the interactive interface;
determining a new content level associated with the desired supply chain management process; and
providing the new content level to one or more service requirement subscribers.

2. The method of claim 1, wherein determining the new content level includes:
receiving a desired service requirement specification associated with each of the received service requirement options;
determining whether a received service requirement option corresponds to an existing supply chain management process, a modification to an existing supply chain management process, or a new supply chain management process based on the desired service requirement specification; and
assigning an adjustment factor to the desired service requirement option based on the determination.

3. The method of claim 2, wherein assigning the new content adjustment factor includes:
establishing a first adjustment factor if the received service requirement option corresponds to a new service requirement; and
establishing a second adjustment factor if the received service requirement option corresponds to a modification to an existing service requirement;
wherein the first new content adjustment factor is greater than the second new content adjustment factor.

4. The method of claim 3, wherein determining a new content level includes calculating the new content level for the supply chain management process based on the established adjustment factor and weight factor for each of the received service requirement options.

5. The method of claim 3, wherein determining the new content level includes:
normalizing the weight factor associated with each of the service requirement options;
determining a new content level for each of the service requirement options by multiplying the adjustment factor by the normalized weight factor; and
calculating the new content level for the service agreement based on the new content level for each of the service requirement options.

6. The method of claim 1, wherein the new content level is indicative of a percentage of an existing supply chain management process that must be modified to implement the desired supply chain management process.

7. The method of claim 1, wherein providing the new content level includes generating a new content report that includes a summary of one or more of new content level associated with one or more subtasks of the desired supply chain management process, new content level associated with the supply chain management process, or recommendations for limiting the new content level associated with the supply chain management process.

8. A computer-readable medium for use on a computer system, the computer-readable medium having computer-executable instructions for performing the method of claim 1.

9. A method for determining a new content level associated with a desired service process comprising:
receiving one or more service requirement options associated with a desired supply chain management process;
determining whether a received service requirement option corresponds to an existing supply chain management process, a modification of an existing supply chain management process, or a new supply chain management process based on the desired service requirement specification; and
selecting an adjustment factor associated with the desired service requirement option based on the determination;
estimating a new content level associated with the desired supply chain management process based on a weight factor associated with the one or more service requirement options and the assigned adjustment factor; and
providing the new content level to one or more subscribers associated with the desired supply chain management process.

10. The method of claim 9, wherein assigning the new content adjustment factor includes:
establishing a first adjustment factor if the received service requirement option corresponds to a new service requirement; and
establishing a second adjustment factor if the received service requirement option corresponds to a modification to an existing service requirement;
wherein the first new content adjustment factor is greater than the second new content adjustment factor.

11. The method of claim 10, wherein determining the new content level includes:
normalizing the weight factor associated with each of the service requirement options;
determining a new content level for each of the service requirement options by multiplying the adjustment factor by the normalized weight factor; and
calculating the new content level for the service agreement based on the new content level for each of the service requirement options.

12. The method of claim 10, wherein determining a new content level includes calculating the new content level for the desired supply chain management process based on the established adjustment factor and weight factor for each of the received service requirement options.

13. A computer-readable medium for use on a computer system, the computer-readable medium having computer-executable instructions for performing the method of claim 10.

14. A system for estimating a new content level associated with a proposed service agreement comprising:
a service requirement definition module having an interactive interface that allows a user to assign a weight factor to one or more service requirement options;
a service requirement selection module communicatively coupled to the service requirement definition module, the service requirement selection module providing an interactive interface for selecting one or more service requirement options associated with a desired service agreement;
a processor operatively coupled to one or more of the service requirement definition module and service requirement selection module and configured to:
receive selected service requirement options from the service requirement selection module;
determine a new content level associated with the service agreement based on the weight factors associated with the selected service requirements; and
provide the new content level to one or more service requirement subscribers.

15. The system of claim 14, wherein the service requirement selection module includes one or more interactive checklists whereby one or more service requirement options are selected to define the desired service agreement.

16. The system of claim 14, wherein determining the new content level includes:
determining whether a received service requirement option corresponds to an existing supply chain management process, a modification to an existing supply chain management process, or a new supply chain management process; and
assigning an adjustment factor to the desired service requirement option based on the determination.

17. The system of claim 16, wherein assigning the new content adjustment factor includes:
establishing a first adjustment factor if the received service requirement option corresponds to a new service requirement; and
establishing a second adjustment factor if the received service requirement option corresponds to a modification to an existing service requirement;
wherein the first adjustment factor is greater than the second adjustment factor.

18. The system of claim 17, wherein determining a new content level includes calculating the new content level for the supply chain management process based on the weight factor and adjustment factors for each of the received service requirement options.

19. The system of claim 16, wherein determining the new content level includes:
normalizing the weight factor associated with each of the service requirement options;
determining a new content level for each of the service requirement options by multiplying the adjustment factor by the normalized weight factor; and
calculating the new content level for the service agreement based on the new content level for each of the service requirement options.

20. The system of claim 14, wherein the supply chain management process includes one or more of an order management process, a manufacturing process, a supply process, an inventory control process, a warehouse management process, a quality assurance process, a transportation management process, a compliance process, a maintenance process, or a technology implementation and development process.
